(19) United States
(12) Patent Application Publication
(10) Pub. No.: US 2026/0354347 A1
(43) Pub. Date: Nov. 12, 2026

(54) CAT SCRATCHING POST

(71) Applicant: ZHANKE CUI, Shenzhen (CN)

(72) Inventor: ZHANKE CUI, Shenzhen (CN)

(21) Appl. No.: 19/727,301

(22) Filed: Jul. 1, 2026

(30) Foreign Application Priority Data
May 22, 2026 (CN) 202610715080.1

(51) Int. Cl. A01K 15/02

(52) U.S. Cl. CPC A01K 15/024

(57) ABSTRACT

A cat scratching post comprises a base assembly, the base assembly comprising a base and a cord-tensioning mechanism, the cord-tensioning mechanism comprising a winding spool, the winding spool being rotatably connected to the base; and a post structure, the post structure comprising one or more connecting posts, one of the connecting posts being a top post; and a tension cord, one end of the tension cord sequentially passing through the connecting posts and being connected to the top post, the other end of the tension cord being connected to the winding spool, the connecting posts being joined in sequence to form an assembled post for scratching and climbing. This configuration enables simpler, more convenient and faster assembly of the cat scratching post, and allows the footprint of the base to be adjusted according to actual operational requirements.

### CROSS-REFERENCE TO RELATED APPLICATIONS

This application claims priority to Chinese Patent Application No. 202610715080.1, filed on May 22, 2026, which is hereby incorporated by reference in its entirety.

### TECHNICAL FIELD

The present application relates to the field of pet supplies, and in particular to a cat scratching post.

### BACKGROUND

A pet refers to a creature kept by people for emotional rather than economic purposes. Pets mainly include fish, reptiles, amphibians, and insects, among others, and are primarily used for companionship to relieve people's mental stress. Among them, the cat is the pet most commonly kept by people; cats are not only adorable but also lively and active, and at the same time they like to scratch, climb, and run indoors, which can easily cause damage to indoor decorations. In order to allow pets to scratch, climb, and play freely, to express their natural instincts, and to allow them to thrive, while minimizing damage to indoor decorations as far as possible, many pet-loving households currently use cat scratching posts.

In existing cat scratching posts, in order to facilitate transportation, the components of the cat scratching post are all separate, and after the product is delivered to a user, the user is required to assemble and fix the components constituting the cat scratching post one by one by means of screws and bolts.

With respect to the related art described above, assembling and fixing the various components constituting the cat scratching post by means of screws and bolts results in the entire assembly process of the cat scratching post being relatively complicated and slow, which leads to a poor user experience.

### SUMMARY

In order to make the assembly of the cat scratching post simpler, more convenient, and faster, and to improve the user experience, the present application provides a cat scratching post.

The cat scratching post provided by the present application adopts the following technical solution:

A cat scratching post comprises a base assembly, the base assembly comprising a base and a cord-tensioning mechanism, the cord-tensioning mechanism being disposed on the base, the cord-tensioning mechanism comprising a winding spool and a ratchet assembly, the winding spool being rotatably connected to the base, the ratchet assembly comprising a ratchet wheel and a locking pawl, the ratchet wheel being coaxially fixed to the winding spool, the locking pawl being rotatably disposed on the base and configured to restrict the ratchet wheel to unidirectional rotation;
and a post structure, the post structure comprising one or more connecting posts, one of the connecting posts being a top post; and a tension cord, one end of the tension cord sequentially passing through the connecting posts and being connected to the top post, the other end of the tension cord being connected to the winding spool, such that when the tension cord is wound around the winding spool, the connecting posts are joined in sequence to form an assembled post for scratching and climbing.

By adopting the above technical solution, when the cat scratching post is being transported, the locking pawl disengages from the ratchet wheel, so that the winding spool unwinds the tension cord, whereby the assembled post is separated into the individual connecting posts, thereby facilitating storage and transportation of the cat scratching post; when the cat scratching post needs to be installed and used, the winding spool is driven to rotate so that the winding spool winds the tension cord, whereby, as tensioned by the top post, the connecting posts are joined to one another in sequence to form the assembled post for scratching and climbing, and the cooperation between the ratchet wheel and the locking pawl keeps the tension cord wound around the winding spool, thereby ensuring the stability of the assembled post and thereby completing the rapid assembly of the cat scratching post, so that the assembly of the cat scratching post is made simpler, more convenient, and faster, addressing the drawback that assembling and fixing the various components constituting the cat scratching post by means of screws and bolts results in the entire assembly process of the cat scratching post being relatively complicated and slow, leading to a poor experience in using the cat scratching post.

Optionally, the ratchet assembly further comprises a locking block, the locking block being rotatably disposed on the base; when the locking block is locked, the locking block abuts against the locking pawl so as to prevent the locking pawl from disengaging from engagement with the ratchet wheel; and when the locking block is unlocked, the locking block releases contact with the locking pawl so that the locking pawl is able to disengage from engagement with the ratchet wheel.

Optionally, the cord-tensioning mechanism further comprises a drive assembly, the drive assembly comprising a drive worm wheel and a drive worm, the drive worm wheel being connected to the winding spool so as to drive the winding spool to rotate, and the drive worm being rotatably disposed on the base and engaging with the drive worm wheel.

Optionally, the drive assembly further comprises a drive pin, the winding spool being provided with a drive groove, the drive pin passing through and being slidably fitted in the drive groove, and the drive pin being connected to the drive worm wheel;
when rotation of the drive worm wheel drives the winding spool to rotate, the drive pin slides along the drive groove to a position where it is interlockingly engaged with a wall of the drive groove, and when rotation of the drive worm wheel is unable to drive the winding spool to rotate, the drive pin slides along the drive groove to a position where it is disengaged from interlocking engagement with the wall of the drive groove.

Optionally, the drive pin is connected with a stop block, the stop block preventing the drive pin from disengaging from the drive groove.

Optionally, the drive assembly further comprises an elastic member, one end of the elastic member being connected to the drive pin and the other end of the elastic member abutting against the base, so as to maintain the interlocking engagement between the drive pin and the drive groove.

Optionally, the base comprises a main body portion, a first sliding portion, and a second sliding portion, the main body portion being provided with a transverse guide rail, the first sliding portion being provided with a longitudinal guide rail, the first sliding portion being slidably fitted to the main body portion via the transverse guide rail, the second sliding portion being slidably fitted to the first sliding portion via the longitudinal guide rail, and the cord-tensioning mechanism being disposed on the second sliding portion.

Optionally, the base assembly further comprises an extension leg mechanism, the extension leg mechanism comprising a support plate, the support plate being slidably fitted to the base, or the support plate being rotatably connected to the base.

Optionally, when the support plate is slidably fitted to the base, the extension leg mechanism further comprises an actuating assembly, the actuating assembly comprising a driven wheel and a connecting rod, the driven wheel being rotatably disposed on the base, one end of the connecting rod being rotatably connected to the support plate, and the other end of the connecting rod being rotatably connected to the driven wheel.

A cat scratching post comprises a base assembly, the base assembly comprising a base and a cord-tensioning mechanism, the cord-tensioning mechanism being disposed on the base, the cord-tensioning mechanism comprising a winding spool and a drive assembly, the winding spool being rotatably connected to the base, the drive assembly comprising a drive worm wheel and a drive worm, the drive worm wheel being connected to the winding spool so as to drive the winding spool to rotate, the drive worm being rotatably disposed on the base and engaging with the drive worm wheel;
and a post structure, the post structure comprising one or more connecting posts, one of the connecting posts being a top post; and a tension cord, one end of the tension cord sequentially passing through the connecting posts and being connected to the top post, the other end of the tension cord being connected to the winding spool, such that when the tension cord is wound around the winding spool, the connecting posts are joined in sequence to form an assembled post for scratching and climbing.

In summary, the present application includes at least one of the following beneficial technical effects:

When the cat scratching post is being transported, the locking pawl disengages from the ratchet wheel, so that the winding spool unwinds the tension cord, whereby the assembled post is separated into the individual connecting posts, thereby facilitating storage and transportation of the cat scratching post; when the cat scratching post needs to be installed and used, the winding spool is driven to rotate so that the winding spool winds the tension cord, whereby, as tensioned by the top post, the connecting posts are joined to one another in sequence to form the assembled post for scratching and climbing, and the cooperation between the ratchet wheel and the locking pawl keeps the tension cord wound around the winding spool, thereby ensuring the stability of the assembled post and thereby completing the rapid assembly of the cat scratching post, so that the assembly of the cat scratching post is made simpler, more convenient, and faster, addressing the drawback that assembling and fixing the various components constituting the cat scratching post by means of screws and bolts results in the entire assembly process of the cat scratching post being relatively complicated and slow, leading to a poor experience in using the cat scratching post.

### BRIEF DESCRIPTION OF THE DRAWINGS

FIG. 1 is a schematic view of the overall structure of an embodiment of the present application;

FIG. 2 is a sectional view of the base assembly of an embodiment of the present application;

FIG. 3 is a schematic structural view of the cord-tensioning mechanism of an embodiment of the present application;

FIG. 4 is a sectional view of the post structure of an embodiment of the present application;

FIG. 5 is a schematic structural view of the ratchet assembly of an embodiment of the present application;

FIG. 6 is a schematic structural view of the drive assembly of an embodiment of the present application;

FIG. 7 is a sectional view of the winding spool of an embodiment of the present application;

FIG. 8 is a first schematic structural view of the cord-tensioning mechanism of an embodiment;

FIG. 9 is a second schematic structural view of the cord-tensioning mechanism of an embodiment;

FIG. 10 is a schematic structural view of the extension leg mechanism of an embodiment of the present application.

Description of reference signs: 1, base assembly; 11, base; 111, main body portion; 1111, transverse guide rail; 112, first sliding portion; 1121, longitudinal guide rail; 113, second sliding portion; 12, cord-tensioning mechanism; 121, winding spool; 1211, drive groove; 1211a, section A; 1211b, section B; 1212, drive auxiliary groove; 122, ratchet assembly; 1221, ratchet wheel; 1222, locking pawl; 1223, retaining spring; 1224, locking block; 123, drive assembly; 1231, drive worm wheel; 1232, drive worm; 1233, drive pin; 12331, stop block; 1234, elastic member; 1241, pivoting hand lever; 1242, tightening hook; 1243, elastic tensioning cord; 125, tensioning bracket; 1251, tensioning groove; 1252, seating groove; 13, extension leg mechanism; 131, support plate; 132, actuating assembly; 1321, driven wheel; 1322, connecting rod; 1323, drive gear; 2, post structure; 2a, assembled post; 21, connecting post; 21a, top post; 211, first coupling structure; 212, second coupling structure; 22, tension cord.

### DETAILED DESCRIPTION

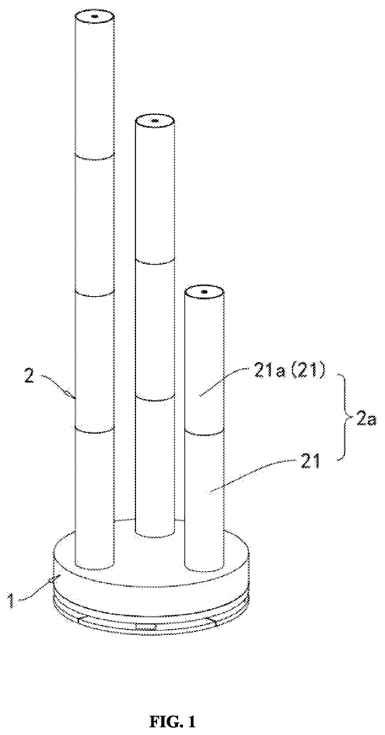

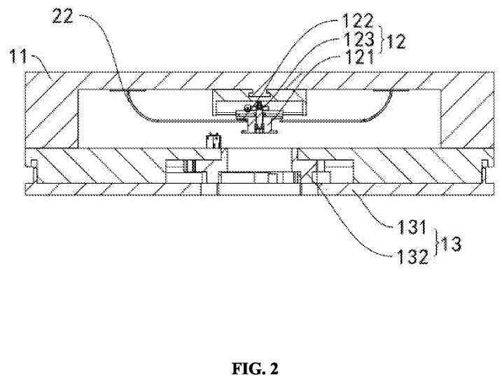

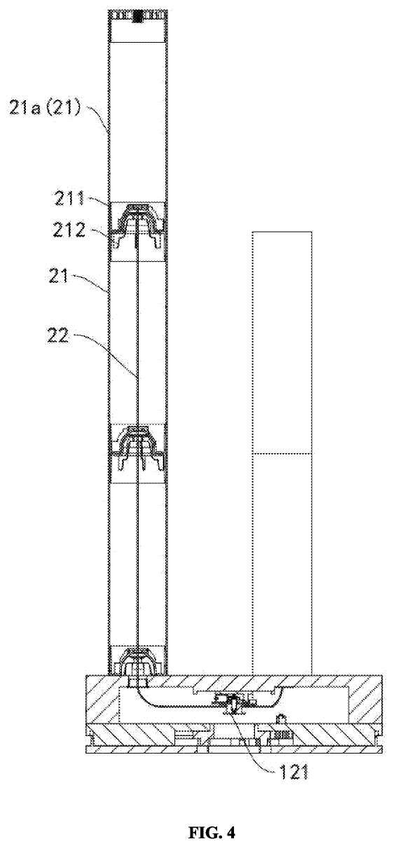

The present application will be further described in detail below in conjunction with FIG. 1 to FIG. 10.

An embodiment of the present application discloses a cat scratching post. Referring to FIG. 1 to FIG. 4, a cat scratching post comprises a base assembly 1 and a post structure 2. The base assembly 1 comprises a base 11 and a cord-tensioning mechanism 12. The cord-tensioning mechanism 12 is disposed on the base 11. The cord-tensioning mechanism 12 comprises a winding spool 121 and a ratchet assembly 122. The winding spool 121 is rotatably connected to the base 11. The ratchet assembly 122 comprises a ratchet wheel 1221 and a locking pawl 1222. The ratchet wheel 1221 is coaxially fixed to the winding spool 121. The locking pawl 1222 is rotatably disposed on the base 11 and is configured to restrict the ratchet wheel 1221 to unidirectional rotation. As will be appreciated, a retaining spring 1223 is disposed between the locking pawl 1222 and the base 11 so as to maintain the engagement between the locking pawl 1222 and the ratchet wheel 1221. The post structure 2 comprises one or more connecting posts 21, one of the connecting posts 21 being a top post 21a; and a tension cord 22, one end of the tension cord 22 sequentially passing through the connecting posts 21 and being connected to the top post 21a, the other end of the tension cord 22 being connected to the winding spool 121, such that when the tension cord 22 is wound around the winding spool 121, the connecting posts 21 are joined in sequence to form an assembled post 2a for scratching and climbing.

Referring to FIG. 1 to FIG. 4, as will be appreciated, the number of connecting posts 21 constituting the assembled post 2a may be one or may be more than one, and the present application does not limit this. In addition, the number of post structures 2 may be one or more, and the present application does not limit this. As will be appreciated, a first coupling structure 211 is provided at a head end of the connecting post 21, and a second coupling structure 212 is provided at a tail end of the connecting post 21. The first coupling structure 211 and the second coupling structure 212 are able to be joined to each other. When the tension cord 22, which sequentially passes through the connecting posts 21 and is connected to the top post 21a, is wound around the winding spool 121, the head end and the tail end of the connecting posts 21 can be joined in sequence via the first coupling structure 211 and the second coupling structure 212 so as to constitute the assembled post 2a.

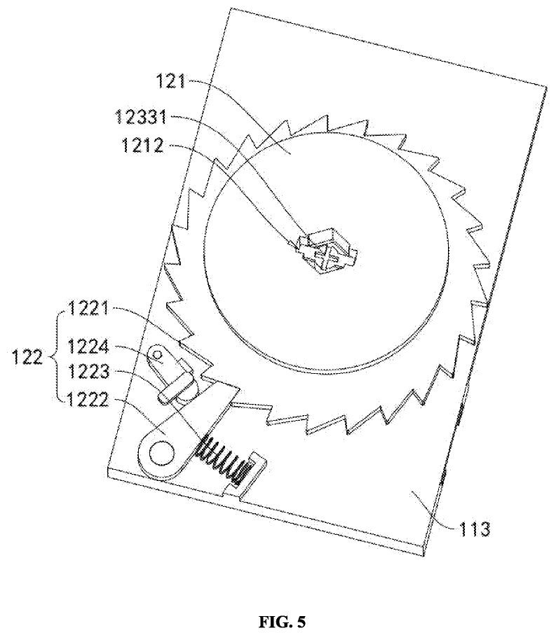

Referring to FIG. 5, in an embodiment of the present application, the ratchet assembly 122 further comprises a locking block 1224. The locking block 1224 is rotatably disposed on the base 11. When the locking block 1224 is locked, the locking block 1224 abuts against the locking pawl 1222 so as to prevent the locking pawl 1222 from disengaging from engagement with the ratchet wheel 1221. When the locking block 1224 is unlocked, the locking block 1224 releases contact with the locking pawl 1222 so that the locking pawl 1222 is able to disengage from engagement with the ratchet wheel 1221, thereby ensuring the stability of the engagement between the locking pawl 1222 and the ratchet wheel 1221. Moreover, when the ratchet assembly 122 needs to release the unidirectional rotation limitation on the winding spool 121, the locking block 1224 is unlocked so that the locking pawl 1222 is able to release contact with the ratchet wheel 1221, whereby the ratchet assembly 122 releases the unidirectional rotation limitation on the winding spool 121, so that the winding spool 121 is able to unwind the tension cord 22.

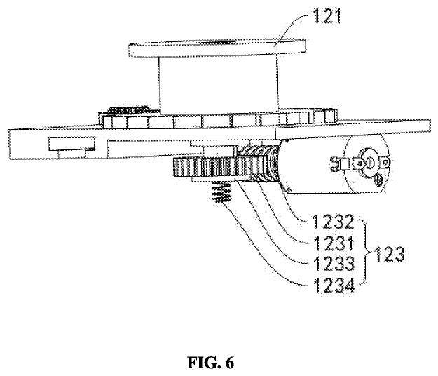

Referring to FIG. 6, in an embodiment of the present application, the cord-tensioning mechanism 12 further comprises a drive assembly 123. The drive assembly 123 comprises a drive worm wheel 1231 and a drive worm 1232. The drive worm wheel 1231 is connected to the winding spool 121 so as to drive the winding spool 121 to rotate. The drive worm 1232 is rotatably disposed on the base 11 and engages with the drive worm wheel 1231. In an embodiment of the present application, the rotation of the drive worm 1232 is driven by a motor; in other embodiments, the drive worm 1232 can also be driven manually.

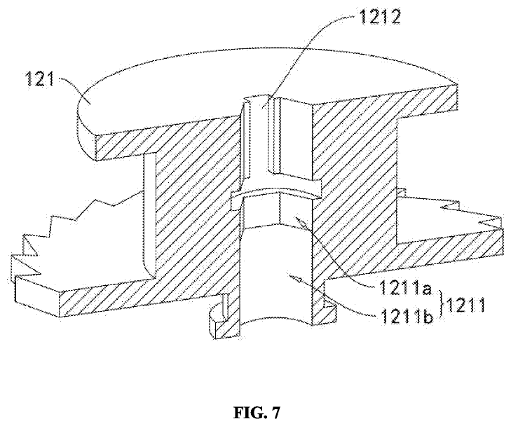

Referring to FIG. 6 and FIG. 7, in a further embodiment, the drive assembly 123 further comprises a drive pin 1233. The winding spool 121 is provided with a drive groove 1211. The drive pin 1233 extends through and is slidably received in the drive groove 1211. The drive pin 1233 is connected to the drive worm wheel 1231. When the rotation of the drive worm wheel 1231 drives the winding spool 121 to rotate, the drive pin 1233 slides along the drive groove 1211 to a position where it is interlockingly engaged with a wall of the drive groove 1211; when the rotation of the drive worm wheel 1231 is unable to drive the winding spool 121 to rotate, the drive pin 1233 slides along the drive groove 1211 to a position where it is disengaged from interlocking engagement with the wall of the drive groove 1211. As will be appreciated, the cross-section of the drive pin 1233 is polygonal. The drive groove 1211 has a section A 1211a and a section B 1211b remote from the section A 1211a. The cross-section of the section A 1211a is polygonal so as to be able to cooperate with the drive pin 1233, and the cross-section of the section B 1211b is circular, such that when the drive pin 1233 slides into and engages section A 1211a, the rotation of the drive pin 1233 can drive the winding spool 121 to rotate; and when the drive pin 1233 slides from the section A 1211a to the section B 1211b, the drive pin 1233 disengages from the drive-transmitting fit with section A, such that the rotation of the drive pin 1233 is unable to drive the winding spool 121 to rotate, whereby, when the winding spool 121 needs to unwind the tension cord 22 or the winding spool 121 needs to be driven to rotate manually, the drive pin 1233 is pushed to slide from the section A 1211a to the section B 1211b, so that the drive assembly 123 disengages from the driving of the rotation of the winding spool 121.

Referring to FIG. 5, in a still further embodiment, the drive pin 1233 is connected with a stop block 12331, and the stop block 12331 prevents the drive pin 1233 from disengaging from the drive groove 1211. As will be appreciated, the connection between the stop block 12331 and the drive pin 1233 is a detachable connection, so that the drive pin 1233 can pass through the drive groove 1211 and the stop block 12331 can prevent the drive pin 1233 from disengaging from the drive groove 1211. In a still further embodiment, the winding spool 121 is provided with a drive auxiliary groove 1212. When the drive pin 1233 slides to the section A 1211a, the stop block 12331 extends through and is slidably received in the drive auxiliary groove 1212 so as to assist the drive pin 1233 in driving the winding spool 121; and when the drive pin 1233 slides to the section B 1211b, the stop block 12331 disengages from the drive auxiliary groove 1212.

Referring to FIG. 6 and FIG. 7, in a still further embodiment, the drive assembly 123 further comprises an elastic member 1234. One end of the elastic member 1234 is connected to the drive pin 1233, and the other end of the elastic member 1234 abuts against the base 11, so as to maintain the interlocking engagement between the drive pin 1233 and the drive groove 1211, that is, to keep the drive pin 1233 always located at the section A 1211a and cooperating with the section A 1211a in a state in which no external force pushes the drive pin 1233 to slide. As will be appreciated, the elastic member 1234 may be a spring or may be another component having elasticity, and the present application does not limit this.

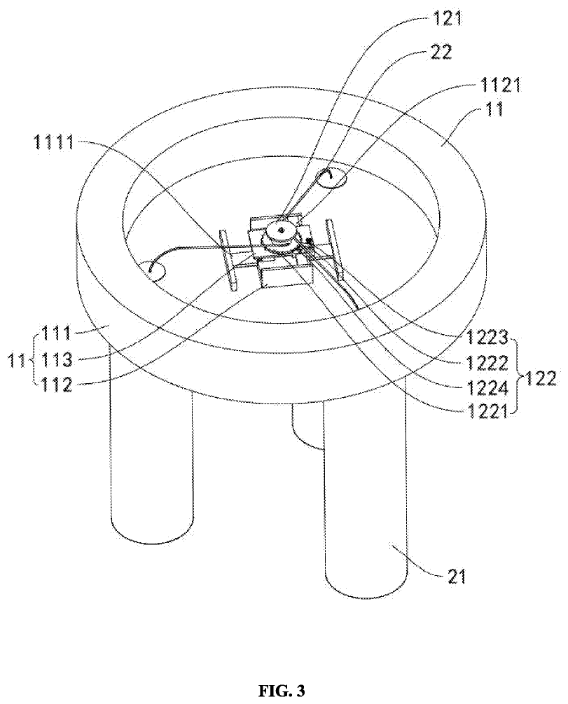

Referring to FIG. 3, in an embodiment of the present application, the base 11 comprises a main body portion 111, a first sliding portion 112, and a second sliding portion 113. The main body portion 111 is provided with a transverse guide rail 1111, and the first sliding portion 112 is provided with a longitudinal guide rail 1121. The first sliding portion 112 is slidably fitted to the main body portion 111 via the transverse guide rail 1111, and the second sliding portion 113 is slidably fitted to the first sliding portion 112 via the longitudinal guide rail 1121. The cord-tensioning mechanism 12 is disposed on the second sliding portion 113, such that when the winding spool 121 winds the tension cord 22, any length discrepancies between the tension cords can be compensated for by relative sliding between the main body portion 111, the first sliding portion 112, and the second sliding portion 113.

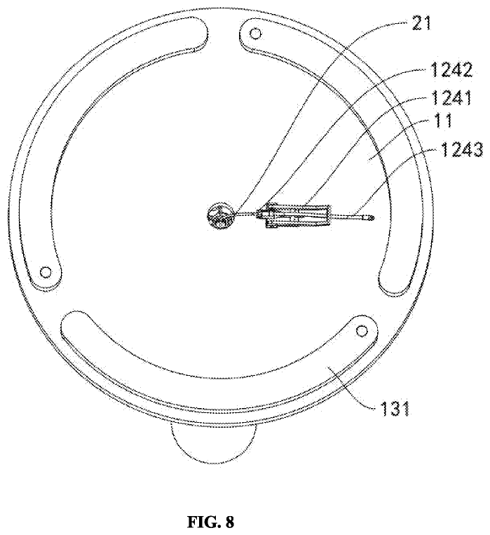

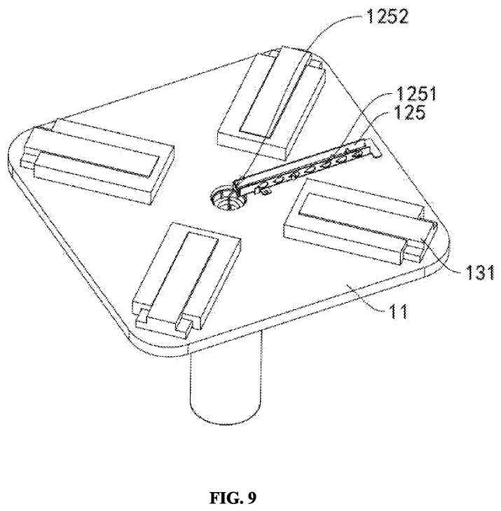

Referring to FIG. 8 and FIG. 9, in other embodiments, the cord-tensioning mechanism 12 can also be another structure capable of tightening the tension cord 22. Referring to FIG. 8, for example, the cord-tensioning mechanism 12 comprises a pivoting hand lever 1241, a tightening hook 1242, and an elastic tensioning cord 1243. The pivoting hand lever 1241 is rotatably disposed on the base 11. The tightening hook 1242 is rotatably connected to the pivoting hand lever 1241 and is hooked to one end of the tension cord 22. One end of the elastic tensioning cord 1243 is connected to the base 11, and the other end of the elastic tensioning cord 1243 is connected to the tension cord 22, such that when the pivoting hand lever 1241 is rotated toward the base 11, the tightening hook 1242 tightens the tension cord 22, wherein the elastic tensioning cord 1243 assists the tightening hook 1242 in tightening the tension cord 22, thereby achieving the tightening of the tension cord 22. Referring to FIG. 9, as another example, the cord-tensioning mechanism 12 comprises a tensioning bracket 125. The tensioning bracket 125 is fixedly disposed on the base 11. The tensioning bracket 125 is provided with a plurality of tensioning grooves 1251 and a plurality of seating grooves 1252. The tensioning grooves 1251 and the seating grooves 1252 are oriented perpendicular to each other. The tensioning bracket 125 is rectangular. The tensioning grooves 1251 are distributed along the length direction of the tensioning bracket 125, and the seating grooves 1252 are evenly distributed along the width direction of the tensioning bracket 125. The distances from the groove bottoms of the seating grooves 1252 to the base 11 increase progressively. When the tension cord 22 is connected to the tensioning bracket 125, the tension cord 22 passes through one of the seating grooves 1252 and is threaded through one of the tensioning grooves 1251. When it is necessary to adjust the tension of the tension cord 22, the tension of the tension cord 22 can be adjusted by having the tension cord 22 pass through a different seating groove 1252 and be threaded through a different tensioning groove 1251.

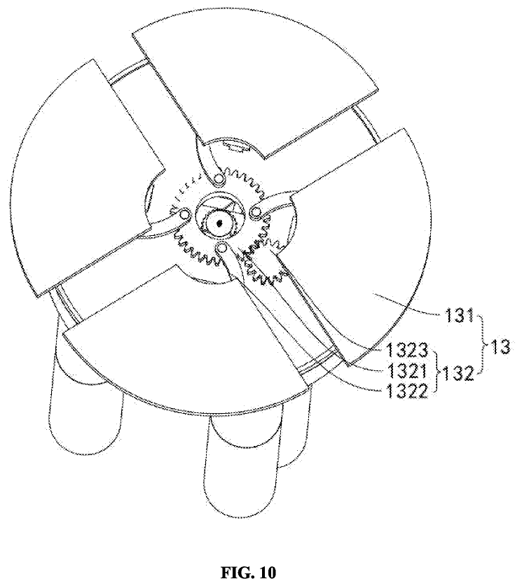

Referring to FIG. 8 to FIG. 10, in an embodiment of the present application, the base assembly 1 further comprises an extension leg mechanism 13. The extension leg mechanism 13 comprises a support plate 131. Referring to FIG. 9 and FIG. 10, the support plate 131 is slidably fitted to the base 11; referring to FIG. 8, alternatively, the support plate 131 is rotatably connected to the base 11. In the embodiments of the present application, the specific connection manner between the support plate 131 and the base 11 is not limited. In a further embodiment, referring to FIG. 10, when the support plate 131 is slidably fitted to the base 11, the extension leg mechanism 13 further comprises an actuating assembly 132. The actuating assembly 132 comprises a driven wheel 1321 and a connecting rod 1322. The driven wheel 1321 is rotatably disposed on the base 11. One end of the connecting rod 1322 is rotatably connected to the support plate 131, and the other end of the connecting rod 1322 is rotatably connected to the driven wheel 1321. In a still further embodiment, the driven wheel 1321 is of a gear structure, and the actuating assembly 132 further comprises a drive gear 1323. The drive gear 1323 is rotatably disposed on the base 11 and engages with the driven wheel 1321. The drive gear 1323 is driven by a motor; upon actuation of the motor, the output shaft thereof drives the drive gear 1323 to rotate, the rotation of the drive gear 1323 drives the driven wheel 1321 to rotate, and the rotation of the driven wheel 1321 pushes the support plate 131 to slide via the connecting rod 1322, so that, ultimately, the diameter of the base 11 can be expanded according to actual needs of use to increase stability, whereby the support plate 131 is able to better support the cat scratching post.

The implementation principle of the cat scratching post in the embodiments of the present application is as follows: when the cat scratching post is being transported, the locking pawl 1222 disengages from the ratchet wheel 1221, so that the winding spool 121 unwinds the tension cord 22, whereby the assembled post 2a is separated into the individual connecting posts 21, thereby facilitating storage and transportation of the cat scratching post; when the cat scratching post needs to be installed and used, the winding spool 121 is driven to rotate so that the winding spool 121 winds the tension cord 22, whereby, as tensioned by the top post 21a, the connecting posts 21 are joined to one another in sequence to form the assembled post 2a for scratching and climbing, and the cooperation between the ratchet wheel 1221 and the locking pawl 1222 keeps the tension cord 22 wound around the winding spool 121, thereby ensuring the stability of the assembled post 2a and thereby completing the rapid assembly of the cat scratching post, so that the assembly of the cat scratching post is made simpler, more convenient, and faster, addressing the drawback that assembling and fixing the various components constituting the cat scratching post by means of screws and bolts results in the entire assembly process of the cat scratching post being relatively complicated and slow, leading to a poor experience in using the cat scratching post.

The above are merely preferred embodiments of the present application and are not intended to limit the scope of protection of the present application accordingly; therefore, all equivalent variations made in accordance with the structure, shape, and principle of the present application shall fall within the scope of protection of the present application.

What is claimed is:

1. A cat scratching post, comprising:
a base assembly, the base assembly comprising a base and a cord-tensioning mechanism, the cord-tensioning mechanism being disposed on the base, the cord-tensioning mechanism comprising a winding spool and a ratchet assembly, the winding spool being rotatably connected to the base, the ratchet assembly comprising a ratchet wheel and a locking pawl, the ratchet wheel being coaxially fixed to the winding spool, the locking pawl being rotatably disposed on the base and configured to restrict the ratchet wheel to unidirectional rotation; and
a post structure, the post structure comprising one or more connecting posts, one of the connecting posts being a top post; and a tension cord, one end of the tension cord sequentially passing through the connecting posts and being connected to the top post, the other end of the tension cord being connected to the winding spool, such that when the tension cord is wound around the winding spool, the connecting posts are joined in sequence to form an assembled post for scratching and climbing.

2. The cat scratching post of claim 1, wherein the ratchet assembly further comprises a locking block, the locking block being rotatably disposed on the base; when the locking block is locked, the locking block abuts against the locking pawl so as to prevent the locking pawl from disengaging from engagement with the ratchet wheel; and when the locking block is unlocked, the locking block releases contact with the locking pawl so that the locking pawl is able to disengage from engagement with the ratchet wheel.

3. The cat scratching post of claim 1, wherein the cord-tensioning mechanism further comprises a drive assembly, the drive assembly comprising a drive worm wheel and a drive worm, the drive worm wheel being connected to the winding spool so as to drive the winding spool to rotate, and the drive worm being rotatably disposed on the base and engaging with the drive worm wheel.

4. The cat scratching post of claim 3, wherein the drive assembly further comprises a drive pin, the winding spool being provided with a drive groove, the drive pin passing through and being slidably fitted in the drive groove, and the drive pin being connected to the drive worm wheel;
when rotation of the drive worm wheel drives the winding spool to rotate, the drive pin slides along the drive groove to a position where it is interlockingly engaged with a wall of the drive groove, and when rotation of the drive worm wheel is unable to drive the winding spool to rotate, the drive pin slides along the drive groove to a position where it is disengaged from interlocking engagement with the wall of the drive groove.

5. The cat scratching post of claim 4, wherein the drive pin is connected with a stop block, the stop block preventing the drive pin from disengaging from the drive groove.

6. The cat scratching post of claim 4, wherein the drive assembly further comprises an elastic member, one end of the elastic member being connected to the drive pin and the other end of the elastic member abutting against the base, so as to maintain the interlocking engagement between the drive pin and the drive groove.

7. The cat scratching post of claim 1, wherein the base comprises a main body portion, a first sliding portion, and a second sliding portion, the main body portion being provided with a transverse guide rail, the first sliding portion being provided with a longitudinal guide rail, the first sliding portion being slidably fitted to the main body portion via the transverse guide rail, the second sliding portion being slidably fitted to the first sliding portion via the longitudinal guide rail, and the cord-tensioning mechanism being disposed on the second sliding portion.

8. The cat scratching post of claim 1, wherein the base assembly further comprises an extension leg mechanism, the extension leg mechanism comprising a support plate, the support plate being slidably fitted to the base, or the support plate being rotatably connected to the base.

9. The cat scratching post of claim 8, wherein, when the support plate is slidably fitted to the base, the extension leg mechanism further comprises an actuating assembly, the actuating assembly comprising a driven wheel and a connecting rod, the driven wheel being rotatably disposed on the base, one end of the connecting rod being rotatably connected to the support plate, and the other end of the connecting rod being rotatably connected to the driven wheel.

10. A cat scratching post, comprising:
a base assembly, the base assembly comprising a base and a cord-tensioning mechanism, the cord-tensioning mechanism being disposed on the base, the cord-tensioning mechanism comprising a winding spool and a drive assembly, the winding spool being rotatably connected to the base, the drive assembly comprising a drive worm wheel and a drive worm, the drive worm wheel being connected to the winding spool so as to drive the winding spool to rotate, the drive worm being rotatably disposed on the base and engaging with the drive worm wheel; and
a post structure, the post structure comprising one or more connecting posts, one of the connecting posts being a top post; and a tension cord, one end of the tension cord sequentially passing through the connecting posts and being connected to the top post, the other end of the tension cord being connected to the winding spool, such that when the tension cord is wound around the winding spool, the connecting posts are joined in sequence to form an assembled post for scratching and climbing.
